(19) United States
(12) Patent Application Publication
(10) Pub. No.: US 2023/0349716 A1
(43) Pub. Date: Nov. 2, 2023

(54) SYSTEMS AND METHODS FOR SIMULATING CHANGE DETECTION DATA

(71) Applicant: Toyota Research Institute, Inc., Los Altos, CA (US)

(72) Inventors: Xipeng Wang, Ann Arbor, MI (US); Ryan M. Wiesenberg, South Lyon, MI (US)

(73) Assignees: Toyota Research Institute, Inc., Los Altos, CA (US); Toyota Jidosha Kabushiki Kaisha, Toyota-shi (JP)

(21) Appl. No.: 17/732,630

(22) Filed: Apr. 29, 2022

(51) Int. Cl. G01C 21/00; G01C 21/36; G01C 21/32; G06N 3/08

(52) U.S. Cl. CPC G01C 21/3815; G01C 21/3826; G01C 21/367; G01C 21/32; G06N 3/08

(57) ABSTRACT

System, methods, and other embodiments described herein relate to simulating change detection data. In one embodiment, a method includes converting features from a standard-definition (SD) map into high-definition (HD) map features. The method includes generating modified map features based upon the HD map features. The method includes training a machine learning model based upon the HD map features and the modified map features. The machine learning model is configured to detect a change between data from an HD map corresponding to an environment and sensor data generated by a vehicle in the environment.

### TECHNICAL FIELD

The subject matter described herein relates, in general, to simulating change detection data, and with more particularity, to generating a synthetic high-definition (HD) map from a standard-definition (SD) map, and simulating changes in the synthetic HD map.

### BACKGROUND

Vehicles may be equipped with sensors that facilitate perceiving other vehicles, obstacles, pedestrians, and additional aspects of a surrounding environment. For example, a vehicle may be equipped with a light detection and ranging (LIDAR) sensor that uses light to scan the surrounding environment, while logic associated with the LIDAR analyzes acquired data to detect a presence of objects and other features of the surrounding environment. In further examples, additional/alternative sensors such as cameras may be implemented to acquire information about the surrounding environment from which a system derives awareness about aspects of the surrounding environment. This sensor data can be useful in various circumstances for improving perceptions of the surrounding environment so that systems such as autonomous driving systems can perceive the noted aspects and accurately plan and navigate accordingly.

While sensors of vehicles facilitate perceiving aspects of environments, deriving a comprehensive representation of an environment using sensors is computationally intensive and may not be possible from a limited perspective of a vehicle over a single pass through a scene, thereby potentially leaving gaps in the situational awareness of the vehicle. As such, vehicles may utilize high-definition (HD) maps in conjunction with sensor data to facilitate navigation about environments. An HD map is a precise map that has information about features of an environment that are not typically found within standard-definition (SD) maps. In an example, the HD map may include features of an environment such as road markings (e.g., lane boundaries, centerlines, etc.), guardrails, signs, poles, and/or traffic lights. Furthermore, the HD map can include detailed attributes for the aforementioned features, such as color and size. Unlike SD maps, the HD map may have centimeter level precision and hence is well-suited for autonomous navigation purposes.

Conventional systems may construct an HD map using probe data generated by specialized sensor equipment mounted on probe vehicles that navigate around environments. Collecting and processing the probe data may be computational burdensome, time consuming, and/or expensive. When an environment changes, such as when a road undergoes changes during construction (e.g., adding a lane and associated lane markings), a probe vehicle typically navigates around the changed environment in order to collect new probe data, which is then used to update the HD map to reflect the changed environment. It is often not feasible to continually collect probe data in this manner. As such, the HD map may become outdated and hence may become unsuitable for use in navigation.

### SUMMARY

In one embodiment, example systems and methods relate to a manner of improving a process of updating an HD map. According to an embodiment, a computing system converts features from an SD map into HD map features. In an example, the features in the SD map include roads and a number of lanes on the roads and the HD map features include road markings. In an example, the HD map features are located in a pseudo-HD (i.e., synthetic) map. The computing system generates modified map features based upon the HD map features. In an example, the modified map features including removing road markings, adding road markings, and/or changing locations of the road markings. The computing system trains a machine learning model based upon the HD map features and the modified map features. The machine learning model is configured to detect a change between data from an HD map corresponding to an environment and sensor data generated by a vehicle in the environment. The computing system may update the HD map based upon a value output by the machine learning model, where the updated HD map reflects a current state of the environment. The above-described process performed by the computing system is an improvement over conventional approaches to updating HD maps, as the above-described processes do not require probe data to update HD maps, avoid computationally burdensome procedures that are normally used to process and classify probe date, and are able to update HD maps at a much more frequent rate than conventional approaches.

In one embodiment, a computing system for simulating change detection data is disclosed. The computing system includes a processor and memory communicably coupled to the processor. The memory includes instructions that, when executed by the processor, cause the processor to convert features from a standard-definition (SD) map into high-definition (HD) map features in a pseudo-HD map. The instructions further cause the processor to generate modified map features based upon the HD map features. The instructions further cause the processor to train a machine learning model based upon the HD map features and the modified map features, wherein the machine learning model is configured to detect a change between data from an HD map corresponding to an environment and sensor data generated by a vehicle in the environment.

In one embodiment, a non-transitory computer-readable medium for simulating change detection data and including instructions that when executed by a processor cause the proessor to convert features from a standard-definition (SD) map into high-definition (HD) map features. The instructions cause the processor to generate modified map features based upon the HD map features. The instructions cause the processor to train a machine learning model based upon the HD map features and the modified map features, wherein the machine learning model is configured to detect a change between data from an HD map corresponding to an environment and sensor data generated by a vehicle in the environment.

In one embodiment, a method is disclosed. In one embodiment, the method includes converting features from a standard-definition (SD) map into high-definition (HD) map features. The method includes generating modified map features based upon the HD map features. The method includes training a machine learning model based upon the HD map features and the modified map features, wherein the machine learning model is configured to detect a change between data from an HD map corresponding to an environment and sensor data generated by a vehicle in the environment.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an environment in which systems and methods disclosed herein may be implemented.

FIG. 2 illustrates one embodiment of a change detection system that is associated with generating simulated change detection data, training a machine learning model based upon the simulated change detection data, and executing the machine learning model to detect changes for an HD map.

FIG. 3 illustrates an HD map feature and example modifications to the HD map feature.

FIG. 4 illustrates one embodiment of an architecture of a machine learning model for change detection.

FIG. 5 illustrates one embodiment of another architecture of a machine learning model for change detection.

FIG. 6 illustrates one embodiment of yet another architecture of a machine learning model for change detection.

FIG. 7 illustrates one embodiment of a vehicle within which systems and methods disclosed herein may be implemented.

FIG. 8 illustrates one embodiment of a method that is associated with training a machine learning model based upon simulated change detection data.

FIG. 9 illustrates one embodiment of a method that is associated with updating an HD map.

### DETAILED DESCRIPTION

Systems, methods, and other embodiments associated with improving change detection for HD maps are disclosed herein. As noted above, HD maps are typically generated based upon probe data from probe vehicles that are equipped with specialized sensors. It is often not feasible to continually run the probe vehicles over an environment. As a result, HD maps may become outdated when the environment changes. An outdated HD map may be unsuitable for navigation purposes for an autonomous vehicle.

To address these issues, a change detection system (“the system”) is described herein. In example operation, the system obtains an SD map of an environment. The SD map may have meter-level accuracy. The SD map may include features in the environment such as road markings, signs, traffic lights, and/or poles. According to embodiments, the SD map comprises nodes and edges connecting the nodes, where the edges represent roads in the environment and the nodes represent junctions in the environment. According to the embodiments, the edges are assigned criteria that are indicative of attributes of the roads, such as a number of lanes on the road, types of the roads (e.g., highway, city, rural, etc.), speed limits of the roads, and/or road markings on the roads.

The system converts the features in the SD map into HD map features. According to embodiments, the system converts the features in the SD map into the HD map features in a pseudo-HD map. In general, the pseudo-HD map is in a format that is similar or identical to an HD map, but unlike the HD map, does not include precise locations and/or attributes of the environment. The system generates modified map features based upon the HD map features. According to embodiments, the system selects an area of the pseudo-HD map that includes an HD map feature, such as a lane marking. In an example, the area represents a 20 m×20 m area. The system generates a rasterized image of the area that includes the HD map feature.

The system performs a modification to the rasterized image in order to generate simulated training data that can be used to train a machine learning model. The modification may include an addition of a second HD map feature (e.g., a second lane marking) to the rasterized image, a removal of the HD map feature from the rasterized image, or a change in location of the HD map feature in the rasterized image (positive change examples). The modification may also include a change in color of the HD map feature in the rasterized image or obscuring a portion of the HD map feature in the rasterized image (negative change examples). The system may store the rasterized image and the modified rasterized image as a pair along with an indication as to whether the pair represents a positive change example or a negative change example. The rasterized image and the modified rasterized image may be images generated from any angle. In an example, the rasterized image and the modified rasterized images are birds-eye-view images. The rasterized image, the modified rasterized image, and the indication can thus serve as simulated training data.

The system trains a machine learning model based upon the HD map features and the modified map features, where the machine learning model is configured to detect a change between data from an HD map corresponding to an environment and sensor data generated by a vehicle in the environment. In an example, the machine learning model includes learned parameters when trained, where values of the learned parameters are based upon the HD map features and the modified map features. In an example, the change detected by the machine learning model may be an addition of a road marking to the environment, a removal of the road marking from the environment, or a change in position of the road marking in the environment. According to embodiments, the machine learning model comprises a convolutional neural network (CNN). As the CNN is trained based upon HD map features and modified HD map features (i.e., simulated change detection data), the CNN is able to detect changes between a current state of an environment as reflected in currently captured sensor data and a past state of the environment as reflected in an HD map. Furthermore, as the CNN is trained based upon positive training examples and negative training examples, the CNN is able to distinguish between changes that should be propagated to the HD map (e.g., the addition of a road marking to a road) and changes that should not be propagated to the HD map (e.g., a change in color of the road marking due to normal wear and tear of the road).

According to embodiments, subsequent to training the machine learning model, the system (or another system) obtains sensor data generated by a vehicle in an environment. In an example, the sensor data includes an image of the environment, as well as potentially other data, such as LiDAR data, GPS data, etc. The system generates a first rasterized image based upon the image. The system determines a location of the vehicle within an HD map based upon the sensor data, where the location of the vehicle within the HD map corresponds to the image of the environment. In an example, the HD map was last updated at a first datetime and the sensor data was generated by a vehicle at a second datetime occurring after the first datetime, and hence the HD map may be outdated. The system generates a second rasterized image based upon the location of the vehicle within the HD map. The first rasterized image and the second rasterized image may be generated from any angle. In an example, the first rasterized image and the second rasterized image are birds-eye-view images. The system provides the first rasterized image and the second rasterized image as input to the machine learning model.

The system obtains a value as output of the machine learning model, where the value is indicative of whether there is a change between the first rasterized image and the second rasterized image. Stated differently, the value may be indicative of whether or not the environment has changed since the HD map was generated/last modified. In an example in which the value indicates that there is a change, the system may modify the HD map to reflect the change. For instance, the system may locate an area within the HD map based upon the sensor data, where the area includes the location of the vehicle. The system may add a feature to the area along with an annotation that is indicative of a type of the feature, remove a feature from area, or change a location of a feature within the area.

The above-described technologies present various advantages over conventional approaches to generating and/or updating HD maps. First, the above-described technologies facilitate updating an HD map without requiring the use of probe data from probe vehicles. Second, as the above-described technologies do not require probe data to update the HD map, the above-described technologies avoid computationally burdensome procedures that are used to process and classify the probe data. Third, the above-described technologies facilitate frequent updates to the HD map, which may not be possible under conventional approaches for updating HD maps.

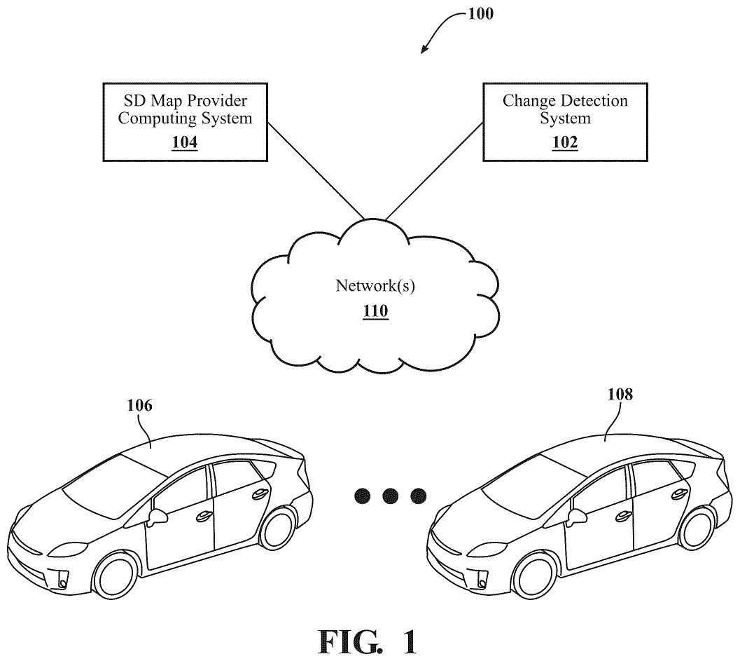

Referring now to FIG. 1, an example environment is illustrated. The environment 100 includes a change detection system 102, an SD map provider computing system 104, a first vehicle 106, and an Nth vehicle 108, where N is a positive integer greater than one.

As will be described in greater detail below, the change detection system 102 is generally configured to convert features from an SD map into HD map features, where the HD map features may be located in a pseudo-HD map. The change detection system 102 is further generally configured to generate modified map features based upon the HD map features. The change detection system 102 is additionally generally configured to train a machine learning model based upon the HD map features and the modified map features, where the machine learning model is configured to detect a change between data from an HD map corresponding to an environment and sensor data generated by a vehicle in the environment. The change detection system 102 may be a remote server or a cloud-computing environment.

The SD map provider computing system 104 is generally configured to maintain an SD map of an environment. According to embodiments, the SD map has approximately meter-level accuracy. The SD map provider computing system 104 and the change detection system 102 may be in communication by one or more networks 110 (referred to now herein as “the network 110”).

The first vehicle 106 and the Nth vehicle 108 are collectively referred to herein as “the plurality of vehicles 106-108.” The plurality of vehicles 106-108 may include autonomous vehicles, semi-autonomous vehicles, or non-autonomous vehicles. The plurality of vehicles 106-108 may include probe vehicles equipped with specialized probe equipment. The plurality of vehicles 106-108 may be in communication with the change detection system 102 by way of the network 110.

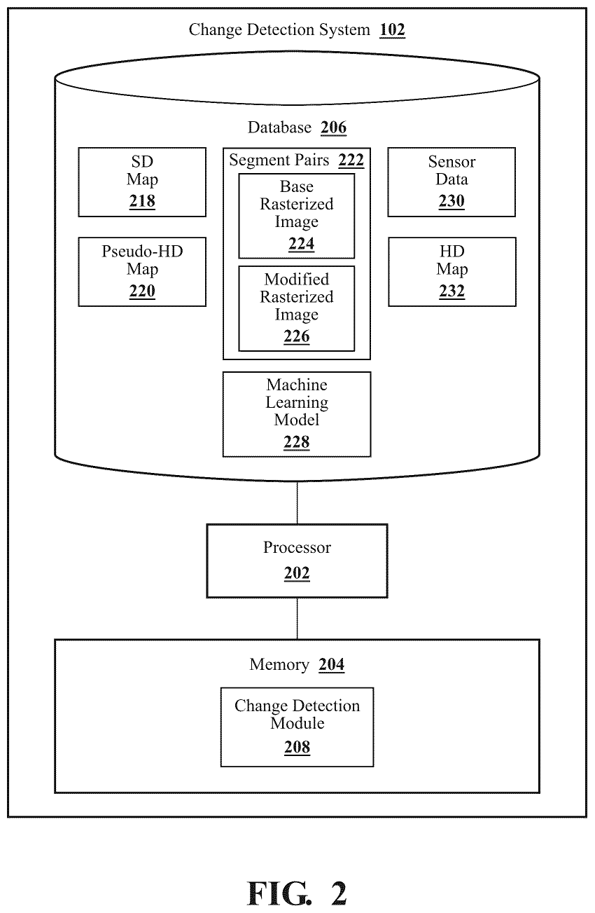

Referring now to FIG. 2, an example of the change detection system 102 is illustrated. The change detection system 102 includes a processor 202, memory 204, and a database 206.

According to embodiments, the memory 204 includes a change detection module 208. According to embodiments, the database 206 includes an SD map 218, a pseudo-HD map 220, and segment pairs 222. In an example, the segment pairs 222 include a base rasterized image 224 and a modified rasterized image 226. According to embodiments, the database 206 also includes a machine learning model 228, sensor data 230, and an HD map 232.

The database 206 is, in one embodiment, an electronic data structure stored in the memory 204 or another data store and that is configured with routines that can be executed by the processor 202 for analyzing stored data, providing stored data, and so on. Thus, in one embodiment, the database 206 stores data used by the change detection module 208 in executing various functions.

The change detection module 208 generally includes instructions for converting features from the SD map 218 into HD map features, where the HD map features may be included in the pseudo-HD map. The change detection module 208 generally includes instructions for generating modified map features based upon HD map features (e.g., generating the segment pairs 222). The change detection module 208 may also generally include instructions for training the machine learning model 228. The change detection module 208 may also generally include instructions for determining whether a change has occurred between a first rasterized image and a second rasterized image using the machine learning model 228, where the change is indicative of a change in an environment. The change detection module 208 may also generally include instructions for updating the HD map 232 based upon a value output by the machine learning model 228.

Example operation of the change detection system 102 is now set forth. The change detection module 208 obtains the SD map 218. In an example, the change detection module 208 receives the SD map 218 from the SD map provider computing system 104 by way of the network 110. In general, the SD map 218 includes features with meter-level accuracy. As such, the SD map 218 may not be suitable for autonomous navigation purposes. The features of the SD map 218 may include information pertaining to roads, numbers of lanes on the roads, types of the roads (e.g., urban, rural, suburban, etc.), and/or speed limits of the roads. According to some embodiments, the features of the SD map 218 include information pertaining to road markings. Road markings may include longitudinal markings, transverse markings, hazard markings, block markings, arrow markings, directional markings, and facility markings. According to some embodiments, the features of the SD map 218 include information pertaining to road signs, traffic lights, and poles.

According to embodiments, the SD map 218 comprises a graph that includes nodes and edges connecting the nodes. The edges represents roads and the nodes represent junctions connecting the nodes. The edges are assigned criteria that is indicative of attributes of the roads. The attributes of the roads may include types of the roads, speed limits of the roads, numbers of lanes of the roads, and road markings on the roads.

The change detection module 208 converts features from the SD map 218 into HD map features. According to embodiments, the change detection module 208 generates the pseudo-HD map 220, where the pseudo-HD map 200 includes the HD map features. In general, the HD map features in the pseudo-HD map 220 are in an HD map format, but may not accurately reflect locations of corresponding features in the real-world. As such, the pseudo-HD map 220 may not be suitable for autonomous navigation purposes. According to embodiments, the pseudo-HD map 220 is an image. The HD map features may include roads and road markings. According to embodiments, the HD map features include road signs, traffic lights, and/or poles.

According to embodiments, the SD map 218 includes information pertaining to roads, numbers of lanes on the roads, and/or types of the roads, but does not include information pertaining to road markings (e.g., lane markings). According to the embodiments, the change detection module 208 generates HD map features corresponding to road markings based upon the number of lanes on the roads. The change detection module 208 may also generate the HD map features corresponding to the road markings based upon types of the roads. In an example, a road has two lanes in which traffic moves in opposite directions. The change detection module 208 estimates dimensions of the road based upon the type of the road. The change detection module 208 also estimates likely positions of road markings based upon the dimensions of the road and the number of lanes of the road. The change detection module 208 generates HD map features corresponding to road markings at the likely positions (e.g., at a center point of the road).

The change detection module 208 generates modified map features based upon the HD map features. According to embodiments in which the pseudo-HD map 220 is an image, the change detection module 208 divides the pseudo-HD map into areas. In an example, each area in the areas represents a 20 m×20 m area in the real-world. The change detection module 208 obtains a area in the areas, where the area includes an HD map feature. In an example, the HD map feature is a lane marking. The change detection module 208 generates the base rasterized image 224 based upon the area in the pseudo-HD map 220, where the base rasterized image 224 includes the HD map feature. The change detection module 208 performs a modification to the base rasterized image 224 to generate the modified rasterized image 226. The modified rasterized image 226 may be a positive change example or a negative change example. A positive change example is meant to encompass a scenario in which a change should be detected. Positive change examples may include removing the HD map feature from the base rasterized image 224, adding a second HD map feature to the base rasterized image 224, or changing a location of the HD map feature within the base rasterized image 224. A negative change example is meant to encompass a scenario in which the modified rasterized image 226 differs in some way from the base rasterized image 224, but that should not be detected as a change. Negative change examples may include changing a color of the HD map feature in the base rasterized image 224 (e.g., to demonstrate normal wear and tear of a road) or obscuring a portion of the HD map feature in the base rasterized image 224 (to demonstrate sensor occlusion). The change detection module 208 may store the base rasterized image 224 and the modified rasterized image 226 as a pair along with an indication as to whether the pair represents a positive change example or a negative change example. The change detection module 208 may repeat this process for different areas to generate the segment pairs 222.

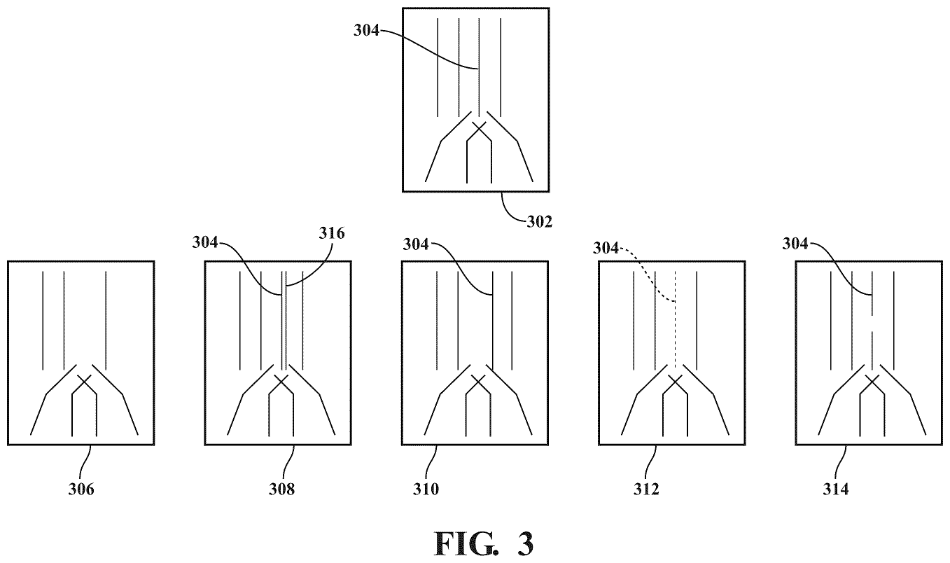

Referring briefly now to FIG. 3, examples of modifications performed by the change detection module 208 are illustrated. FIG. 3 illustrates a base rasterized image 302. The base rasterized image 302 may be or include the base rasterized image 224. The base rasterized image 302 includes lane markings (illustrated as lines in FIG. 3). The lane markings include a lane marking 304.

FIG. 3 also illustrates a first modified rasterized image 306, a second modified rasterized image 308, a third modified rasterized image 310, a fourth modified rasterized image 312, and a fifth modified rasterized image 314 (collectively referred to herein as “the modified rasterized images 306-314). The modified rasterized image 226 may be or include one (or more) of the modified rasterized images 306-314. The first modified rasterized image 306 illustrates removal of the lane marking 304 from the base rasterized image 302. The second modified rasterized image 308 illustrates adding a second lane marking 316 to the base rasterized image 302. The third modified rasterized image 310 illustrates changing a location of the lane marking 304 in the base rasterized image 302. The fourth modified rasterized image 312 illustrates changing a color of the lane marking 304 (illustrated by a dotted line in FIG. 3). The fifth modified rasterized image 314 illustrates obscuring a portion of the lane marking 304 in the base rasterized image 302.

Referring back to FIG. 2, the change detection module 208 trains the machine learning model 228 based upon the HD map features and the modified map features, wherein the machine learning model 228 is configured to detect a change between data from an HD map corresponding to an environment and sensor data generated by a vehicle in the environment. In general, the machine learning model 228 includes learned parameters (e.g., weights) that are based upon the HD map features and the modified map features. According to embodiments, the change detection module 208 trains the machine learning model 228 based upon the segment pairs 222 (which include the HD map features, the modified map features, and indications as to whether each of the segment pairs is a positive change example or a negative change example). According to embodiments, the machine learning model 228 comprises a CNN. According to embodiments, the machine learning model 228 comprises a binary classifier.

According to embodiments, the change detection module 208 obtains the sensor data 230, where the sensor data 230 is generated by a vehicle in an environment (e.g., a vehicle in the plurality of vehicles 106-108). The sensor data 230 includes an image of the environment. The sensor data 230 may also include additional data such as LiDAR data, radar data, sonar data, and/or GPS data. The sensor data 230 may include metadata that characterize various aspects of the sensor data 230. For example, the metadata can include location coordinates (e.g., longitude and latitude), relative map coordinates or tile identifiers, time/date stamps from when the separate sensor data was generated, and so on. In one embodiment, the sensor data 230 represents a combination of perceptions acquired from multiple sensors. The sensor data 230 may also include, for example, information about lane markings, and so on. According to embodiments, the sensor data 230 is about an area that encompasses 360 degrees a vehicle. In alternative embodiments, the sensor data 230 is gathered about a forward direction alone when, for example, the vehicle is not equipped with further sensors to include additional regions about the vehicle and/or the additional regions are not scanned due to other reasons (e.g., unnecessary due to known current conditions).

The change detection module 208 obtains a first rasterized image based upon the sensor data 230. For instance, the change detection module 208 may generate the first rasterized image based upon the image of the environment in the sensor data 230. The change detection module 208 also determines a location of the vehicle within the HD map 232 based upon the sensor data 230. According to embodiments, the change detection module 208 performs a simultaneous localization and mapping (SLAM) process to determine the location of the vehicle within the HD map 232. In general, the HD map 232 has centimeter level accuracy and may be suitable for autonomous navigation purposes. The change detection module 208 generates a second rasterized image based upon the location of the vehicle within the HD map 232. In an example, the vehicle generates the sensor data 230 at a first datetime (i.e., a date and a time on the date) and the HD map 232 was last updated at a second datetime, where the first datetime occurs after the second datetime. As such, the HD map 232 may be out of date and may not accurately reflect a current state of the environment. Stated differently, the first rasterized image and the second rasterized image correspond to the same area in the environment, but at different times.

The change detection module 208 provides the first rasterized image and the second rasterized image as input to the machine learning model 228. The machine learning model 228 outputs a value based upon the first rasterized image, the second rasterized image, and the learned parameters, where the value is indicative of whether a change has occurred between the first rasterized image and the second rasterized image. Stated differently, the value is indicative of whether or not a change has occurred in the environment. The change may be an addition of a road marking in the environment, a removal of the road marking in the environment, or a change in location of the road marking in the environment. The change may also be an addition of the road sign/traffic light/pole in the environment, a removal of a road sign/traffic light/pole in the environment, or a change in location of the road sign/traffic light/pole in the environment.

According to embodiments, the change detection module 208 updates the HD map 232 based upon the value output by the machine learning model 228. In an example, when the value indicates that the environment has changed, the change detection module 208 modifies the HD map 232 to reflect the change.

According to an example, the change is an addition of a feature (e.g., a road marking) to the environment. The change detection module 208 locates an area within the HD map 232 based upon the sensor data 230. The change detection module 208 adds the feature to the area in the HD map 232 based upon the change detected by the machine learning model 228 and the sensor data 230. The change detection module 208 may also add an annotation to the feature in the HD map 232, where the annotation is indicative of a type of the feature. The change detection module 208 may obtain the annotation by utilizing a classifier machine learning model on the sensor data 230 and/or the first rasterized image. Alternatively, the change detection module 208 may obtain the annotation from a human annotator.

According to an example, the change is a removal of a feature (e.g., a road marking) from the environment. The change detection module 208 locates an area within the HD map 232 based upon the sensor data 230. The change detection module 208 removes the feature (and an annotation for the feature) from the area in the HD map 232 based upon the change detected by the machine learning model 228 and the sensor data 230.

According to an example, the change is a feature (e.g., a road marking) being moved from a first location to a second location in the environment. The change detection module 208 locates an area within the HD map 232 based upon the sensor data 230. The change detection module 208 changes a location of the feature within the area from a first position to a second position based upon the change detected by the machine learning model 228 and the sensor data 230.

According to embodiments, the change detection module 208 receives sensor data from a plurality of vehicles, where each instance of the sensor data corresponds to the environment. The change detection module 208 performs the above-described processes on each instance of the sensor data in order to determine whether a change has occurred in the environment. The change detection module 208 updates the HD map 232 when the machine learning model 228 outputs a threshold number of values indicating that the environment has changed.

According to embodiments, vehicles (e.g., the plurality of vehicles 106-108) are controlled based upon the (updated) HD map 232, that is, autonomous driving modules of the vehicles base navigational decisions upon the (updated) HD map 232 and sensor data generated by the vehicles. In an example, the change detection system 102 causes the (updated) HD map 232 (or a portion thereof) to be distributed to the vehicles. In the example, the autonomous driving modules of the vehicles control the vehicles based upon the (updated) HD map 232 (or the portion thereof) and the sensor data.

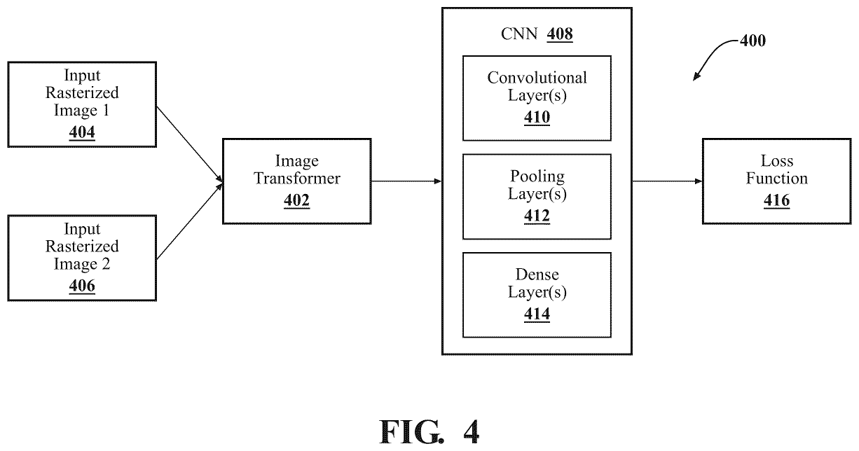

Referring now to FIG. 4, an example architecture 400 of a machine learning model is depicted. The architecture 400 may be or include the machine learning model 228 described above. The architecture 400 includes an image transformer 402 that performs pre-processing on a first input rasterized image 404 and a second input rasterized image 406. At training, the first input rasterized image 404 may include an HD map feature from the pseudo-HD map 220 and the second input rasterized image 406 may include a modified map feature. For instance, the first input rasterized image 404 may be the base rasterized image 224 and the second input rasterized image 406 may be the modified rasterized image 226. At inference, the first input rasterized image 404 may be generated based upon the sensor data 230 (e.g., based upon an image of the environment as captured by the vehicle) and the second input rasterized image 406 may be generated based upon a location of the vehicle within the HD map 232 (described above).

Subsequent to pre-processing, the first input rasterized image 404 and the second input rasterized image 406 are provided as input to a CNN 408. The CNN 408 includes at least one convolutional layer 410, at least one pooling layer 412, and at least one dense layer 414. In general, the at least one convolutional layer 410 is configured to perform a convolution operation on pixel values of the first input rasterized image 404 and the second input rasterized image 406. The at least one convolutional layer 410 includes weights that are generated and modified during a training process. The at least one convolutional layer 410 may have an activation function such as rectified linear unit (ReLU). In general, the at least one pooling layer 412 performs a pooling operation on output of the at least one convolutional layer 410. The pooling operation may be max-pooling or average pooling. The pooling operation may reduce dimensionality of output of the at least one convolutional layer 410. The architecture 400 includes at least one dense layer 414 (i.e., fully connected layer) that has learned weights and that is configured to output a value based upon convolved features generated by the at least one convolutional layer 410 and the at least one pooling layer 412, where the value is indicative of whether a change is detected between the first input rasterized image 404 and the second input rasterized image 406. The CNN 408 has an associated loss function 416 that specifies how training penalizes deviation between predicted output of the CNN 408 and data labels (e.g., whether a change should or should not be detected between the first input rasterized image 404 and the second input rasterized image 406). According to embodiments, the loss function 416 is cross-entropy loss.

According to embodiments, the CNN 408 is pre-trained based upon a collection of images. According to the embodiments, images in the segment pairs 222 are provided as input to the (pretrained) CNN 408 and a plurality of convolved features are generated. According to the embodiments, a dense layer of the (pretrained) CNN 408 is replaced with the at least one dense layer 414, where the at least one dense layer 414 is trained based upon the plurality of convolved features. According to some embodiments, weights of the at least one convolutional layer 410 are updated via back-propagation.

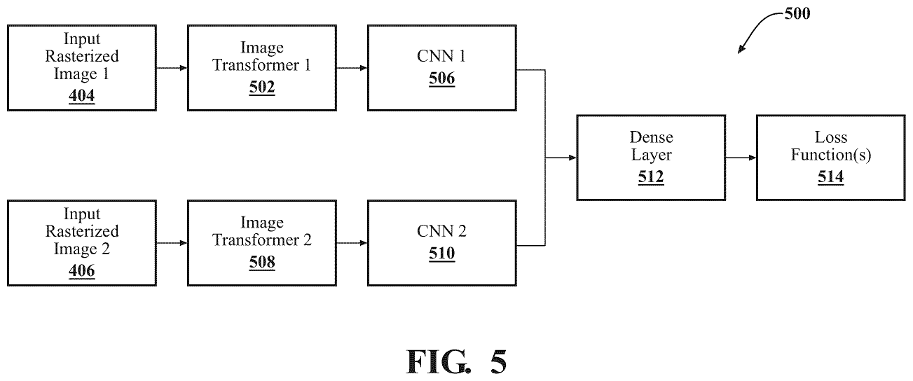

Referring now to FIG. 5, an example architecture 500 of a machine learning model is depicted. The architecture 500 may be or include the machine learning model 228 described above. The architecture 500 includes a first image transformer 502 that performs pre-processing on the first input rasterized image 404. The architecture 500 includes a first CNN 506 that is similar to or identical to the CNN 408 described above. The first CNN 506 outputs first convolved features based upon weights and the first input rasterized image 404. The architecture 500 includes a second image transformer 508 that performs pre-processing on the second input rasterized image 406. The architecture 500 includes a second CNN 510 that is similar to or identical to the CNN 408 described above. The first CNN 506 and the second CNN 510 share the same weights. The second CNN 510 outputs second convolved features based upon the weights and the second input rasterized image 406. The architecture 500 includes a dense layer 512 that is configured to output a value based upon second weights, the first convolved features, and the second convolved features, where the value is indicative of whether there is a change between the first input rasterized image 404 and the second input rasterized image 406. The architecture 500 further includes at least one loss function 514. According to embodiments, the at least one loss function 514 includes contrastive loss and/or cross-entropy loss.

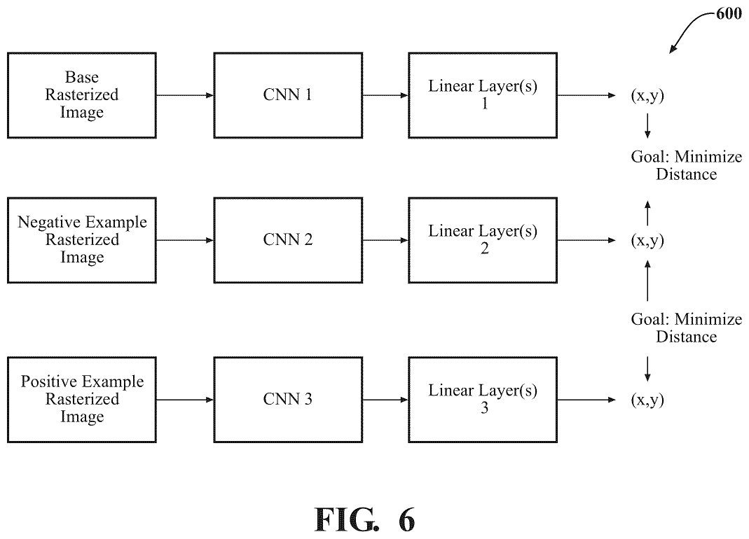

Referring now to FIG. 6, an example architecture 600 of a machine learning model is depicted. The architecture 600 may be or include the machine learning model 228 described above. The architecture 600 depicts a triplet network.

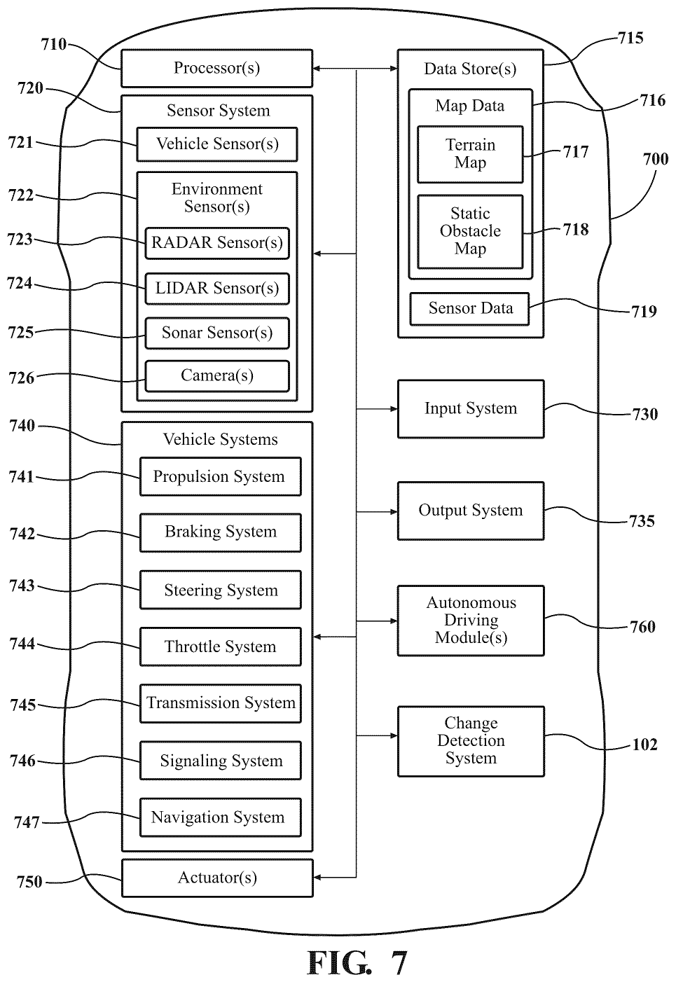

Referring to FIG. 7, an example of a vehicle 700 is illustrated. The vehicle 700 may be included in the plurality of vehicles 106-108 described above. As used herein, a “vehicle” is any form of motorized transport. In one or more implementations, the vehicle 700 is an automobile. While arrangements will be described herein with respect to automobiles, it will be understood that embodiments are not limited to automobiles. In some implementations, the vehicle 700 may be any robotic device or form of motorized transport that, for example, includes sensors to perceive aspects of the surrounding environment, and thus benefits from the functionality discussed herein associated with navigating based upon an HD map (e.g., the HD map 232), where the HD map has been updated based upon output of a machine learning model (e.g., the machine learning model 228), where the machine learning model has been trained based upon simulated change detection data (e.g., data from the pseudo-HD map 220), and where the simulated change detection data is generated based upon data from an SD map (e.g., the SD map 218). As a further note, this disclosure generally discusses the vehicle 700 as traveling on a roadway with surrounding vehicles, which are intended to be construed in a similar manner as the vehicle 700 itself. That is, the surrounding vehicles can include any vehicle that may be encountered on a roadway by the vehicle 700.

The vehicle 700 also includes various elements. It will be understood that in various embodiments it may not be necessary for the vehicle 700 to have all of the elements shown in FIG. 7. The vehicle 700 can have any combination of the various elements shown in FIG. 7. Further, the vehicle 700 can have additional elements to those shown in FIG. 7. In some arrangements, the vehicle 700 may be implemented without one or more of the elements shown in FIG. 7. While the various elements are shown as being located within the vehicle 700 in FIG. 7, it will be understood that one or more of these elements can be located external to the vehicle 700. Further, the elements shown may be physically separated by large distances. For example, as discussed, one or more components of the disclosed system can be implemented within a vehicle while further components of the system are implemented within a cloud-computing environment or other system that is remote from the vehicle 700.

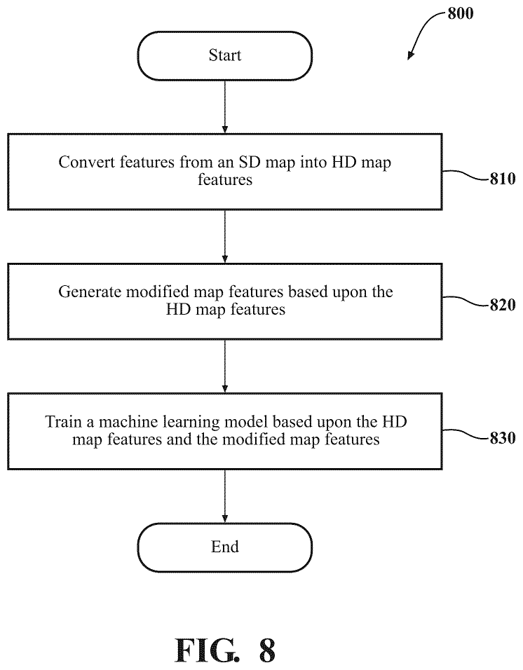

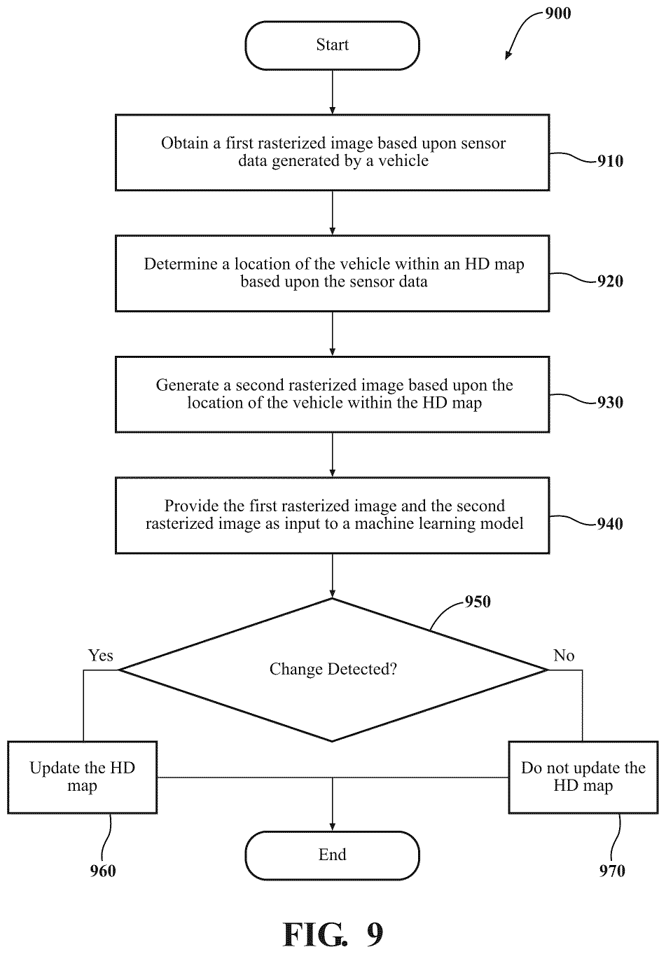

Some of the possible elements of the vehicle 700 are shown in FIG. 7 and will be described along with subsequent figures. However, a description of many of the elements in FIG. 7 will be provided after the discussion of FIGS. 8 and 9 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 700 includes may include the change detection system 102. The change detection system 102, in various embodiments, is implemented partially within the vehicle 700 and as a cloud-based service. For example, in one approach, functionality associated with at least one module of change detection system 102 is implemented within the vehicle 700 while further functionality is implemented within a cloud-based computing system.

For instance, according to embodiments, the vehicle 700 includes the database 206, the machine learning model 228, the sensor data 230, the HD map 232, the processor 202, the memory 204, and the change detection module 208. The change detection module 208 performs a portion of the processes described above to update the HD map 232 based upon the sensor data 230 and data from the HD map 232 to reflect a current state of an environment of the vehicle 700.

According to embodiments, the vehicle 700 includes the database 206, the sensor data 230, the processor 202, and the memory 204. The vehicle 700 transmits the sensor data 230 to the change detection module 208 (which executes on a remote server or a cloud-based computing system). The change detection module 208 performs a portion of the processes described above to update the HD map 232 based upon the sensor data 230 and data from the HD map 232 to reflect a current state of an environment.

Additional aspects of the change detection system 102 will be discussed in relation to FIGS. 8 and 9. FIG. 8 illustrates a flowchart of a method 800 that is associated with training a machine learning model based upon simulated change detection data. The method 800 will be discussed from the perspective of the change detection system 102 of FIGS. 1 and 2. While method 800 is discussed in combination with the change detection system 102, it should be appreciated that the method 800 is not limited to being implemented within the change detection system 102 but is instead one example of a system that may implement the method 800.

At 810, the change detection module 208 converts features from the SD map 218 into HD map features. According to embodiments, the change detection module 208 generates the pseudo-HD map 220, where the pseudo-HD map 220 includes the HD map features. In an example, the HD map features in the pseudo-HD map 220 include lane markings. According to embodiments, the change detection module 208 converts the features from the SD map 218 into the HD map features by upsampling the features from the SD map 218.

At 820, the change detection module 208 generates modified map features based upon the HD map features. According to embodiments, the modified map features are located in the pseudo-HD map 220.

At 830, the change detection module 208 trains the machine learning model 228 based upon the HD map features and the modified map features. The machine learning model 228 is configured to detect a change between data from the HD map 232 corresponding to an environment and the sensor data 230 generated by a vehicle (e.g., the vehicle 700) in the environment. In an example, the change is selected from a group including an addition of a road marking to the environment, a removal of the road marking from the environment, or the road marking moving from a first location to a second location in the environment. According to embodiments, training the machine learning model 228 comprises training a CNN to detect the change. According to embodiments, training the machine learning model 228 comprises training a binary classifier that outputs an indication as to whether the change has occurred based upon a first rasterized image and a second rasterized image, where the first rasterized image is generated based upon the sensor data 230 and where the second rasterized image is generated based upon the data from the HD map 232. According to embodiments, the change detection module 208 trains the machine learning model 228 under a supervised learning process. For instance, the base rasterized image 224 and the modified rasterized image 226 serve as a training sample and the indication as to whether the base rasterized image 224 and the modified rasterized image 226 form a positive change example or a negative change example serves as a desired output that is the origin of a loss signal for the machine learning model 228.

FIG. 9 illustrates a flowchart of a method 900 that is associated updating an HD map (e.g., the HD map 232). The method 900 will be discussed from the perspective of the change detection system 102 of FIGS. 1 and 2. While method 900 is discussed in combination with the change detection system 102, it should be appreciated that the method 900 is not limited to being implemented within the change detection system 102 but is instead one example of a system that may implement the method 900.

At 910, the change detection module 208 obtains a first rasterized image based upon the sensor data 230 generated by a vehicle (e.g., the vehicle 700). In an example, the sensor data 230 includes an image of an environment of the vehicle 700 and the change detection module 208 rasterizes the image to generate the first rasterized image. The sensor data 230 may also include other data such as LiDAR data, radar data, etc.

At 920, the change detection module 208 determines a location of the vehicle 700 within the HD map 232 based upon the sensor data 230. In an example, the sensor data 230 was generated by the vehicle 700 at a first datetime and the HD map 232 was last updated at a second datetime, where the first datetime occurs after the second datetime.

At 930, the change detection module 208 generates a second rasterized image based upon the location of the vehicle within the HD map 232. The first rasterized image and the second rasterized image corresponds to the same area in the environment.

At 940, the change detection module 208 provides the first rasterized image and the second rasterized image as input to the machine learning model 228, where the machine learning model 228 has been trained based upon simulated change detection data (e.g., the segment pairs 222) as described above.

At 950, the change detection module 208 determines whether the HD map 232 reflects a current state of the environment based upon an output of the machine learning model 228, that is, the change detection module 208 determines whether a change is detected.

At 960, when a change is detected, the change detection module 208 updates the HD map 232 based upon the sensor data 230, where the updated HD map reflects the current state of the environment. In an example, the change detection module 208 locates a feature in the HD map 232 based upon the sensor data 230. In the example, the change detection module 208 removes the feature from the HD map 232 based upon the change detected by the machine learning model 228. At 970, when a change is not detected, the change detection module 208 does not update the HD map 232.

FIG. 7 will now be discussed in full detail as an example environment within which the system and methods disclosed herein may operate. In some instances, the vehicle 700 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 700 can be a conventional vehicle that is configured to operate in only a manual mode.

In one or more embodiments, the vehicle 700 is an autonomous vehicle. As used herein, “autonomous vehicle” refers to a vehicle that operates in an autonomous mode. “Autonomous mode” refers to navigating and/or maneuvering the vehicle 700 along a travel route using one or more computing systems to control the vehicle 700 with minimal or no input from a human driver. In one or more embodiments, the vehicle 700 is highly automated or completely automated. In one embodiment, the vehicle 700 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 700 along a travel route.

The vehicle 700 can include one or more processors 710. In one or more arrangements, the processor(s) 710 can be a main processor of the vehicle 700. For instance, the processor(s) 710 can be an electronic control unit (ECU). The vehicle 700 can include one or more data stores 715 for storing one or more types of data. The data store 715 can include volatile and/or non-volatile memory. Examples of suitable data stores 715 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 715 can be a component of the processor(s) 710, or the data store 715 can be operatively connected to the processor(s) 710 for use thereby. The term “operatively connected,” as used throughout this description, can include direct or indirect connections, including connections without direct physical contact.

In one or more arrangements, the one or more data stores 715 can include map data 716. The map data 716 can include maps of one or more geographic areas. In some instances, the map data 716 can include information or data on roads, traffic control devices, road markings, structures, features, and/or landmarks in the one or more geographic areas. The map data 716 can be in any suitable form. In some instances, the map data 716 can include aerial views of an area. In some instances, the map data 716 can include ground views of an area, including 360-degree ground views. The map data 716 can include measurements, dimensions, distances, and/or information for one or more items included in the map data 716 and/or relative to other items included in the map data 716. The map data 716 can include a digital map with information about road geometry. The map data 716 can be high quality and/or highly detailed. In an example, the map data 716 can be or include the HD map 232 described above.

In one or more arrangements, the map data 716 can include one or more terrain maps 117. The terrain map(s) 717 can include information about the ground, terrain, roads, surfaces, and/or other features of one or more geographic areas. The terrain map(s) 717 can include elevation data in the one or more geographic areas. The map data 716 can be high quality and/or highly detailed. The terrain map(s) 717 may be or include the HD map 232 described above. The terrain map(s) 717 can define one or more ground surfaces, which can include paved roads, unpaved roads, land, and other things that define a ground surface.

In one or more arrangements, the map data 716 can include one or more static obstacle maps 718. The static obstacle map(s) 718 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 718 can have location data, size data, dimension data, material data, and/or other data associated with it. The static obstacle map(s) 718 can include measurements, dimensions, distances, and/or information for one or more static obstacles. The static obstacle map(s) 718 can be high quality and/or highly detailed. The static obstacle map(s) 718 may be or include the HD map 232 described above. The static obstacle map(s) 718 can be updated to reflect changes within a mapped area.

The one or more data stores 715 can include sensor data 719. In this context, “sensor data” means any information about the sensors that the vehicle 700 is equipped with, including the capabilities and other information about such sensors. As will be explained below, the vehicle 700 can include the sensor system 720. The sensor data 719 can relate to one or more sensors of the sensor system 720. As an example, in one or more arrangements, the sensor data 719 can include information on one or more LIDAR sensors 724 of the sensor system 720. The sensor data 719 may be or include the sensor data 230 described above.

In some instances, at least a portion of the map data 716 and/or the sensor data 719 can be located in one or more data stores 715 located onboard the vehicle 700. Alternatively, or in addition, at least a portion of the map data 716 and/or the sensor data 719 can be located in one or more data stores 715 that are located remotely from the vehicle 700.

As noted above, the vehicle 700 can include the sensor system 720. The sensor system 720 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 720 includes a plurality of sensors, the sensors can work independently from each other. Alternatively, two or more of the sensors can work in combination with each other. In such case, the two or more sensors can form a sensor network. The sensor system 720 and/or the one or more sensors can be operatively connected to the processor(s) 710, the data store(s) 715, and/or another element of the vehicle 700 (including any of the elements shown in FIG. 7). The sensor system 720 can acquire data of at least a portion of the external environment of the vehicle 700 (e.g., nearby vehicles).

The sensor system 720 can include any suitable type of sensor. Various examples of different types of sensors will be described herein. However, it will be understood that the embodiments are not limited to the particular sensors described. The sensor system 720 can include one or more vehicle sensors 721. The vehicle sensor(s) 721 can detect, determine, and/or sense information about the vehicle 700 itself. In one or more arrangements, the vehicle sensor(s) 721 can be configured to detect, and/or sense position and orientation changes of the vehicle 700, such as, for example, based on inertial acceleration. In one or more arrangements, the vehicle sensor(s) 721 can include one or more accelerometers, one or more gyroscopes, an inertial measurement unit (IMU), a dead-reckoning system, a global navigation satellite system (GNSS), a global positioning system (GPS), a navigation system 747, and/or other suitable sensors. The vehicle sensor(s) 721 can be configured to detect, and/or sense one or more characteristics of the vehicle 700. In one or more arrangements, the vehicle sensor(s) 721 can include a speedometer to determine a current speed of the vehicle 700.

Alternatively, or in addition, the sensor system 720 can include one or more environment sensors 722 configured to acquire, and/or sense driving environment data. “Driving environment data” includes data or information about the external environment in which an autonomous vehicle is located or one or more portions thereof. For example, the one or more environment sensors 722 can be configured to detect, quantify and/or sense obstacles in at least a portion of the external environment of the vehicle 700 and/or information/data about such obstacles. Such obstacles may be stationary objects and/or dynamic objects. The one or more environment sensors 722 can be configured to detect, measure, quantify and/or sense other things in the external environment of the vehicle 700, such as, for example, lane markers, signs, traffic lights, traffic signs, lane lines, crosswalks, curbs proximate the vehicle 700, off-road objects, etc.

Various examples of sensors of the sensor system 720 will be described herein. The example sensors may be part of the one or more environment sensors 722 and/or the one or more vehicle sensors 721. However, it will be understood that the embodiments are not limited to the particular sensors described.

As an example, in one or more arrangements, the sensor system 720 can include one or more radar sensors 723, one or more LIDAR sensors 724, one or more sonar sensors 725, and/or one or more cameras 726. In one or more arrangements, the one or more cameras 726 can be high dynamic range (HDR) cameras or infrared (IR) cameras.

The vehicle 700 can include an input system 730. An “input system” includes any device, component, system, element or arrangement or groups thereof that enable information/data to be entered into a machine. The input system 730 can receive an input from a vehicle passenger (e.g., a driver or a passenger). The vehicle 700 can include an output system 735. An “output system” includes any device, component, or arrangement or groups thereof that enable information/data to be presented to a vehicle passenger (e.g., a person, a vehicle passenger, etc.).

The vehicle 700 can include one or more vehicle systems 740. Various examples of the one or more vehicle systems 740 are shown in FIG. 7. However, the vehicle 700 can include more, fewer, or different vehicle systems. It should be appreciated that although particular vehicle systems are separately defined, each or any of the systems or portions thereof may be otherwise combined or segregated via hardware and/or software within the vehicle 700. The vehicle 700 can include a propulsion system 741, a braking system 742, a steering system 743, throttle system 744, a transmission system 745, a signaling system 746, and/or a navigation system 747. Each of these systems can include one or more devices, components, and/or a combination thereof, now known or later developed.

The navigation system 747 can include one or more devices, applications, and/or combinations thereof, now known or later developed, configured to determine the geographic location of the vehicle 700 and/or to determine a travel route for the vehicle 700. The navigation system 747 can include one or more mapping applications to determine a travel route for the vehicle 700. The navigation system 747 can include a global positioning system, a local positioning system, or a geolocation system.

The processor(s) 710 and/or the autonomous driving module(s) 760 can be operatively connected to communicate with the various vehicle systems 740 and/or individual components thereof. For example, returning to FIG. 7, the processor(s) 710 and/or the autonomous driving module(s) 760 can be in communication to send and/or receive information from the various vehicle systems 740 to control the movement, speed, maneuvering, heading, direction, etc. of the vehicle 700. The processor(s) 710 and/or the autonomous driving module(s) 760 may control some or all of these vehicle systems 740 and, thus, may be partially or fully autonomous.

The processor(s) 710 and/or the autonomous driving module(s) 760 may be operable to control the navigation and/or maneuvering of the vehicle 700 by controlling one or more of the vehicle systems 740 and/or components thereof. For instance, when operating in an autonomous mode, the processor(s) 710 and/or the autonomous driving module(s) 760 can control the direction and/or speed of the vehicle 700. The processor(s) 710 and/or the autonomous driving module(s) 760 can cause the vehicle 700 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 700 can include one or more actuators 750. The actuators 750 can be any element or combination of elements operable to modify, adjust and/or alter one or more of the vehicle systems 740 or components thereof to responsive to receiving signals or other inputs from the processor(s) 710 and/or the autonomous driving module(s) 760. Any suitable actuator can be used. For instance, the one or more actuators 750 can include motors, pneumatic actuators, hydraulic pistons, relays, solenoids, and/or piezoelectric actuators, just to name a few possibilities.

The vehicle 700 can include one or more modules, at least some of which are described herein. The modules can be implemented as computer-readable program code that, when executed by a processor 710, implement one or more of the various processes described herein. One or more of the modules can be a component of the processor(s) 710, or one or more of the modules can be executed on and/or distributed among other processing systems to which the processor(s) 710 is operatively connected. The modules can include instructions (e.g., program logic) executable by one or more processor(s) 710. Alternatively, or in addition, one or more data store 715 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 700 can include one or more autonomous driving modules 760. The autonomous driving module(s) 760 can be configured to receive data from the sensor system 720 and/or any other type of system capable of capturing information relating to the vehicle 700 and/or the external environment of the vehicle 700. In one or more arrangements, the autonomous driving module(s) 760 can use such data to generate one or more driving scene models. The autonomous driving module(s) 760 can determine position and velocity of the vehicle 700. The autonomous driving module(s) 760 can determine the location of obstacles, obstacles, or other environmental features including traffic signs, trees, shrubs, neighboring vehicles, pedestrians, etc.

The autonomous driving module(s) 760 can be configured to receive, and/or determine location information for obstacles within the external environment of the vehicle 700 for use by the processor(s) 710, and/or one or more of the modules described herein to estimate position and orientation of the vehicle 700, vehicle position in global coordinates based on signals from a plurality of satellites, or any other data and/or signals that could be used to determine the current state of the vehicle 700 or determine the position of the vehicle 700 with respect to its environment for use in either creating a map or determining the position of the vehicle 700 in respect to map data.

The autonomous driving module(s) 760 can be configured to determine travel path(s), current autonomous driving maneuvers for the vehicle 700, future autonomous driving maneuvers and/or modifications to current autonomous driving maneuvers based on data acquired by the sensor system 720, driving scene models, and/or data from any other suitable source. In an example, the autonomous driving module(s) 760 can control the vehicle 700 based upon the HD map 232, where the HD map 232 has been modified using the processes described above. “Driving maneuver” means one or more actions that affect the movement of a vehicle. Examples of driving maneuvers include: accelerating, decelerating, braking, turning, moving in a lateral direction of the vehicle 700, changing travel lanes, merging into a travel lane, and/or reversing, just to name a few possibilities. The autonomous driving module(s) 760 can be configured can be configured to implement determined driving maneuvers. The autonomous driving module(s) 760 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 760 can be configured to execute various vehicle functions and/or to transmit data to, receive data from, interact with, and/or control the vehicle 700 or one or more systems thereof (e.g., one or more of vehicle systems 740).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A computing system for simulating change detection data, the computing system comprising:
a processor; and
memory communicably coupled to the processor that includes instructions that, when executed by the processor, cause the processor to:
convert features from a standard-definition (SD) map into high-definition (HD) map features in a pseudo-HD map;
generate modified map features based upon the HD map features; and
train a machine learning model based upon the HD map features and the modified map features, wherein the machine learning model is configured to detect a change between data from an HD map corresponding to an environment and sensor data generated by a vehicle in the environment.

2. The computing system of claim 1, wherein the features from the SD map comprise a graph that includes nodes and edges connecting the nodes, wherein the edges represent roads and the nodes represent junctions connecting the roads.

3. The computing system of claim 2, wherein the edges are assigned criteria that is indicative of attributes of the roads.

4. The computing system of claim 3, wherein the attributes of the roads include at least one of:
numbers of lanes on the roads;
road markings on the roads;
types of the roads; or
speed limits of the roads.

5. The computing system of claim 1, wherein generate the modified map features based upon the HD map features comprises:
select an area of the pseudo-HD map that includes an HD map feature;
generate a rasterized image of the area, wherein the area includes the HD map feature;
perform a modification to the rasterized image; and
generate a modified rasterized image based upon the rasterized image with the modification.

6. The computing system of claim 5, wherein the modification is one of:
remove the HD map feature from the rasterized image;
add a second HD map feature to the rasterized image;
change a location of the HD map feature within the rasterized image; or
change a color of the HD map feature within the rasterized image.

7. The computing system of claim 5, wherein the rasterized image and the modified rasterized image are stored as a pair along with an indication as to whether the pair is a positive change example or a negative change example.

8. The computing system of claim 1, wherein the instructions further cause the processor to:
locate an area in the HD map based upon the sensor data;
add a feature to the HD map based upon the change detected by the machine learning model; and
add an annotation to the feature in the HD map that is indicative of a type of the feature.

9. The computing system of claim 1, wherein the instructions further cause the processor to:
control vehicles based upon an updated HD map that is generated based upon the change detected by the machine learning model.

10. A non-transitory computer-readable medium for simulating change detection data and including instructions that, when executed by a processor, cause the processor to:
convert features from a standard-definition (SD) map into high-definition (HD) map features;
generate modified map features based upon the HD map features; and
train a machine learning model based upon the HD map features and the modified map features, wherein the machine learning model is configured to detect a change between data from an HD map corresponding to an environment and sensor data generated by a vehicle in the environment.

11. The non-transitory computer-readable medium of claim 10, wherein the instructions further cause the processor to:
obtain a first rasterized image based upon the sensor data, wherein the first rasterized image is indicative of the environment of the vehicle;
determine a location of the vehicle within the HD map based upon the sensor data;
generate a second rasterized image based upon the location of the vehicle within the HD map;
provide the first rasterized image and the second rasterized image as input to the machine learning model; and
determine whether the HD map reflects a current state of the environment based upon an output of the machine learning model.

12. The non-transitory computer-readable medium of claim 11, wherein the instructions further cause the processor to:
modify the HD map based upon the output of the machine learning model.

13. The non-transitory computer-readable medium of claim 11, wherein the first rasterized image and the second rasterized image are birds-eye-view images.

14. A method comprising:
converting features from a standard-definition (SD) map into high-definition (HD) map features;
generating modified map features based upon the HD map features; and
training a machine learning model based upon the HD map features and the modified map features, wherein the machine learning model is configured to detect a change between data from an HD map corresponding to an environment and sensor data generated by a vehicle in the environment.

15. The method of claim 14, wherein training the machine learning model comprises training a binary classifier that outputs an indication as to whether the change has occurred in the environment based upon a first rasterized image and a second rasterized image, wherein the first rasterized image is generated based upon the sensor data, and wherein the second rasterized image is generated based upon the data from the HD map.

16. The method of claim 14, wherein the change is selected from a group including:
an addition of a road marking to the environment;
a removal of the road marking from the environment; and
the road marking moving from a first location to a second location in the environment.

17. The method of claim 14, further comprising:
locating a feature in the HD map based upon the sensor data; and
removing the feature from the HD map based upon change detected by the machine learning model.

18. The method of claim 14, wherein training the machine learning model includes training a convolutional neural network (CNN) to detect the change.

19. The method of claim 14, wherein converting the features from the SD map into the HD map features comprises generating a pseudo-HD map.

20. The method of claim 14, wherein the HD map features include lane markings.
